(19) United States
(12) Patent Application Publication
(10) Pub. No.: US 2008/0239413 A1
(43) Pub. Date: Oct. 2, 2008

(54) Auditing System and Method for Digital Documents

(76) Inventors: Chau Vuong, Garden Grove, CA (US); Nhan Qui Vuong, Garden Grove, CA (US); Nam Nguyen, Midway City, CA (US)

Correspondence Address: Chau Vuong, 11712 Lampson Ave., Garden Grove, CA, 92840, US

(21) Appl. No.: 11/691,495

(22) Filed: Mar. 27, 2007

(51) Int. Cl. G06F 17/00

(52) U.S. Cl. 358/496

(57) ABSTRACT

The present invention relates to management of digital documents, and more specifically to a method and system for effectively auditing data extracted from digital documents by creating hyperlinks to these digital documents from the summary documents. The present invention discloses a method and system for auditing data extracted from digital documents by automatically generating hyperlinks on the summary documents to effectively locate the data from these digital documents. The present system consists of several elements including: original documents, digital documents, data documents, note documents, summary documents, and a document organizer.

### CLAIM OF BENEFIT TO PRIORITY APPLICATIONS

This patent application claims the benefit of the earlier filed Provisional Patent Application No. 60/785,766, filed Mar. 24, 2006.

### TECHNICAL FIELD

The present invention relates to management of digital documents, and more specifically to a method and system for effectively auditing data extracted from digital documents by creating hyperlinks to these digital documents from the summary documents.

### BACKGROUND OF THE INVENTION

Current digital document management systems organize files in a file system hierarchy consisting of folders and files. Digital representations of documents usually are images or pdf files. Auditors and tax preparers usually use a summary document, usually called a workpaper, a spreadsheet or form to sum up numbers or organize information (data) extracted from the digital documents.

However, auditing data that are extracted from these digital formats are difficult because imputers have no way to link the data from the digital document to the summary document. They have to create the hyperlink on the spreadsheet by hand every time they input a number on a summary document to point to the supporting digital document. When the checker, reviewing the summary document, want to see where the original data came from, they have to look for the digital document to determine if the data was inputted right from the digital document, wasting a lot of time.

### SUMMARY OF THE INVENTION

The present invention discloses a method and system for auditing data extracted from digital documents by automatically generating hyperlinks on the summary documents to effectively locate the data from these digital documents. The present system consists of several elements including: original documents, digital documents, data documents, note documents, summary documents, and a document organizer. The original document are scanned and transformed to digital document and data document. The Digital Document is a PDF or image of the original document. This is considered a supporting document. This could also be a video clip. The Data Document is when the Original or digital document is converted into a text, word processor, or spreadsheet file. This is considered a supporting document. The Note Document is an annotation document that lays on top if the digital document that allows highlighting, circling, and comment box or bubble, arrows attached to a comment. This document's opacity can be adjusted with a slider. This is considered a supporting document. The Summary Document is a spreadsheet, document, or form to summarize data collected from the digital document and data document. The Document Organizer allows users to navigate to specific document, digital document, or data document.

Another embodiment of this system allows customizable file naming and tagging. Renaming filenames of supporting documents will allow modification of the links to these supporting documents to the new filenames. Renaming filenames of summary documents will also allow modification of the links to these summary documents to the new filenames.

### BRIEF DESCRIPTION OF THE DRAWINGS

Various features of this method and system, which are believed to be novel, are set forth with particularity in the appended claims. The present system and method may best be understood by reference to the following description, taken in connection with the accompanying drawings.

FIG. 1 displays the load mode.

FIG. 2 exhibits how supporting documents are created from raw scans and automatically renamed.

FIG. 3 is displays a view of the summary document.

FIG. 4 displays the input mode.

FIG. 5 exhibits the different possible locations of hyperlinks with respect to the data.

FIGS. 6A-6C show the three different ways that supporting documents can be displayed when a user clicks on a hyperlink to view the supporting documents.

FIG. 7 displays the annotation mode.

### DETAILED DESCRIPTION OF THE DRAWINGS

The following detailed description is of the best presently contemplated mode of carrying out the present invention. This description is not to be taken in a limiting sense, but is made merely for the purpose of illustrating general principles of embodiments of the present invention. The scope of the present invention is best defined by the appended claims.

The present invention provides a system and method of effectively auditing data extracted from digital documents by creating hyperlinks to these digital documents from the summary documents.

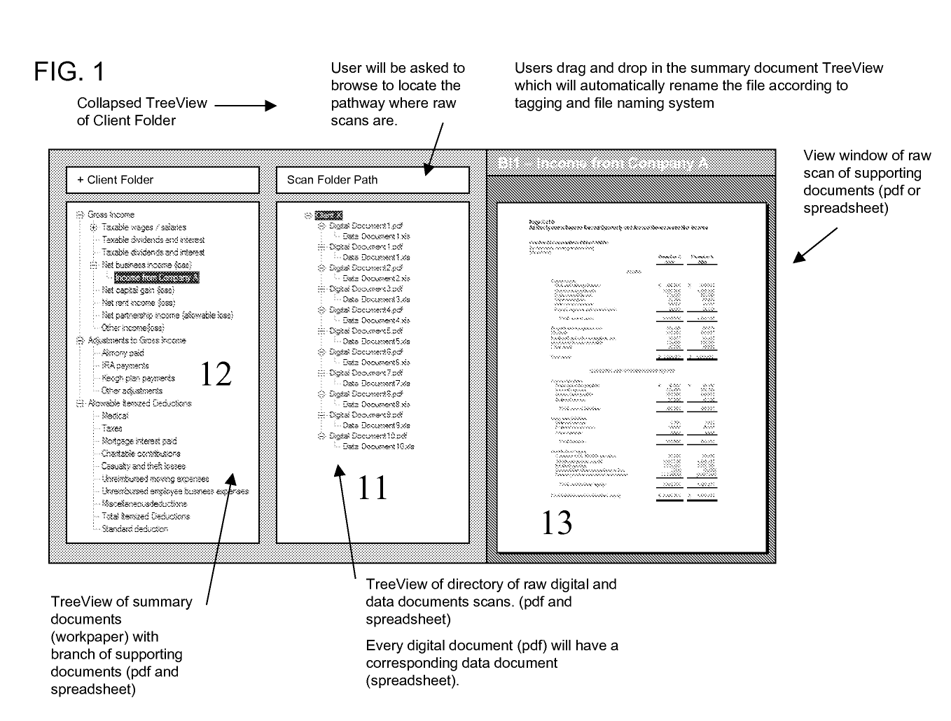

FIG. 1 displays the load mode where raw scans 11 are converted into supporting documents 13 by the user dragging and dropping the scans into the organizer 12. Raw scans 11 are digital documents of the original documents.

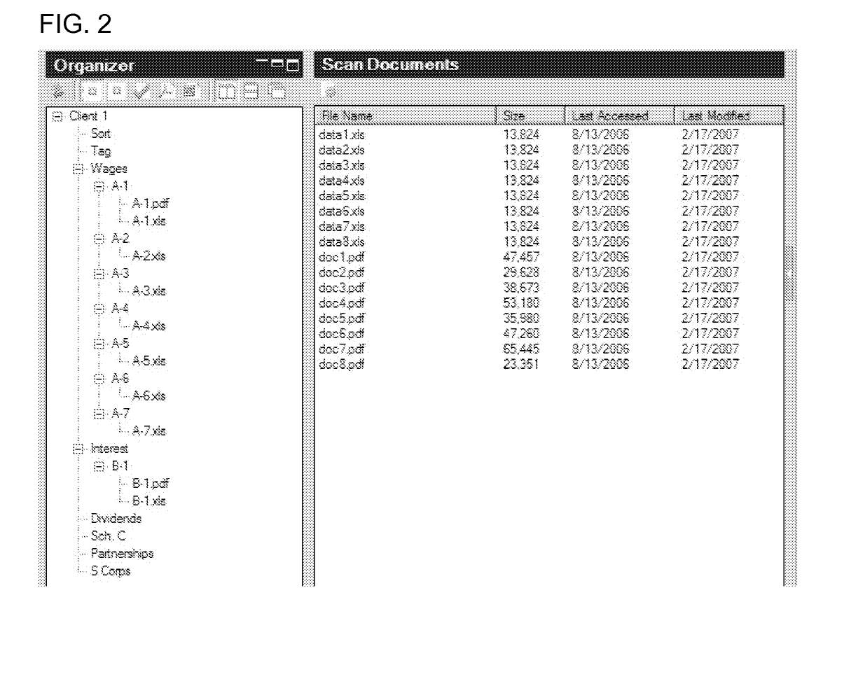

FIG. 2 shows how the scan documents 21 are automatically renamed according to the tagging and file naming system 22 after the user drags and drop the scans into the their corresponding summary document node in the organizer 23.

The Document Organizer allows users to navigate to specific document, digital document, or data document. Summary documents file naming and tagging system are customizable. Moving documents or renaming filenames tags of supporting documents will activate a script that will search for the links to original documents and modify the links to the new name, tag, or path. Moving or renaming summary document will also activate a script that will search for the links to the summary document and modify the links to the new name, tag or path.

Selecting a summary document node on the tree and then scanning the original document or dragging and dropping a supporting document under a summary document node will automatically rename and tag the supporting documents using predefined tags or filename. Changing the order of the supporting document will also cause renaming of the supporting documents name and tags.

Users can predefine search keywords for each summary document so the organizer can search the raw support document scans. If the supporting document fits the keyword search query, it will be automatically sort under its respected summary document as well as being automatically tagged and renamed based on the tagging and naming system.

Below is an example of the file name and tagging system. Tags are in parenthesis and consist of letters and a number. Letters can be combined to from a word, like “Business Income1” to from a tag. Numbers in the tag represent the order of list of supporting documents of the summary document. In this case “Business Income Summary” with the tag “BI”: Business Income Summary (BI)—W2 from Company A (BI-1) and 1099 from Company B (BI-2).

Tags can be either after or before the file name or file description. The Organizer has 3 audit views which users can switch to. Audit Mode 1 allows users see a digital document with its corresponding data document on left or right. Audit Mode 2 allows users see a digital document with its corresponding data document on top or on the bottom. Audit Mode 3 allows users to see digital document and corresponding data document overlapping each other. A slider is offered to change the opacity of the top layer to see the document below.

Hyperlinking Copy and Paste Application—An application or application add-in that copy and paste data between summary document and supporting document. Pasting to the summary document will automatically generate links to the supporting documents. Copying and pasting is done by clicking a button or icon, typing in a clicking a series of keyboard keys (hot key), clicking on a mouse button, drag and drop, or selecting from a pull down menu. When a user copy text or number from a supporting document, the application will determine the name and path of the supporting document. If it is a digital document, it will check to see if a corresponding data document exist, and vice versa. When the user paste, hyperlinks will appear. These hyperlinks can be next (left or right, top or bottom) to the data being pasted. The data itself can be hyperlinked. The hyper link tag can either be alphanumeric text or an image or icon. Links can be created within a supporting document, between supporting documents, within a summary document, between summary documents, between summary documents and supporting documents.

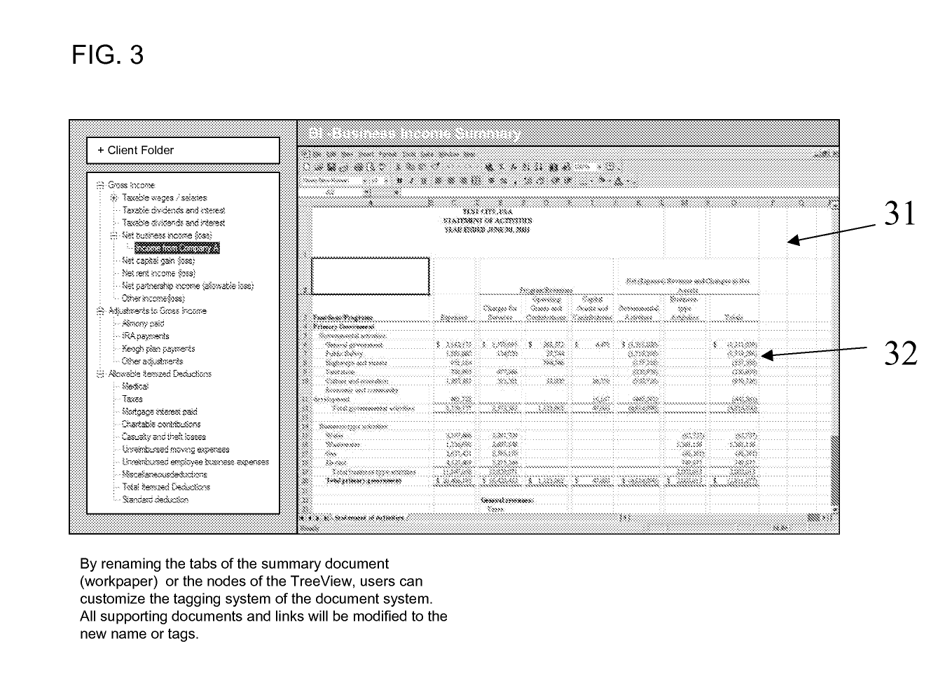

FIG. 3 exhibits a view of the summary document 31 data 32 extracted and summarized from the supporting documents.

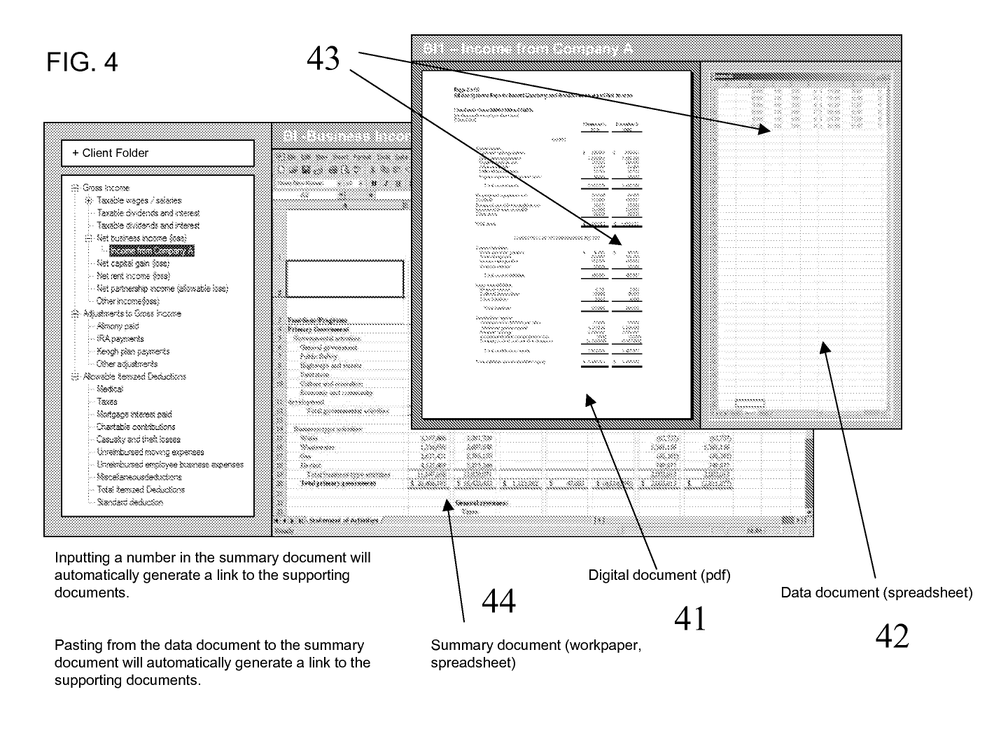

FIG. 4 displays the input mode where hyperlinks are formed on the summary document 44 when the data 43 from the supporting documents 41 and 42 are transferred to the summary document 44.

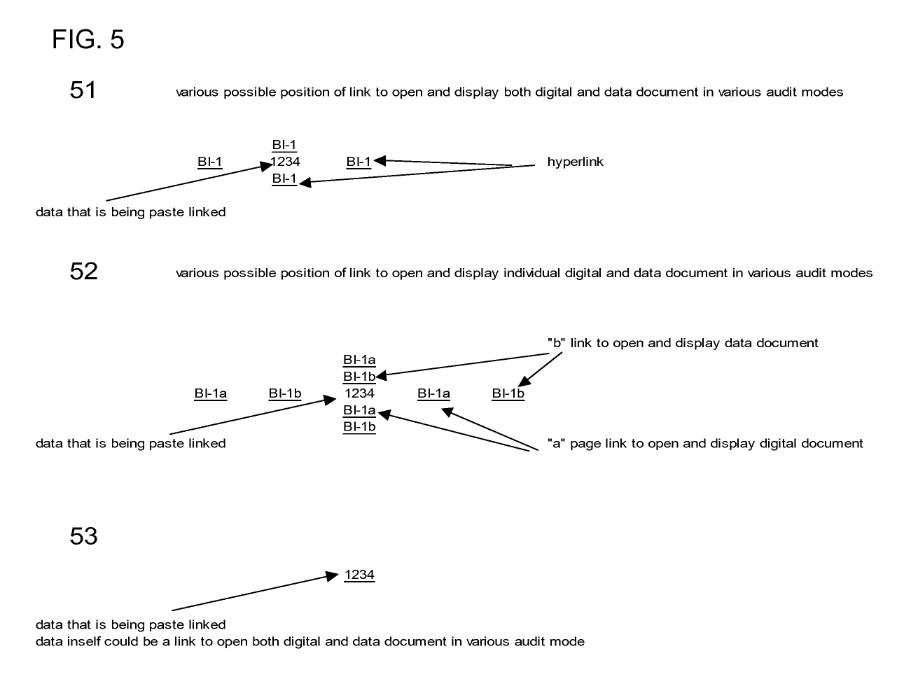

FIG. 5 displays the possible different positions of the hyperlinks 51 with respect to the data 52 on the summary document. The hyperlinks may be positioned above 53, below 54, of adjacent 55 to the data 52 on the summary document. Hyperlinks may be linked to individual data document or digital document or simultaneously to both documents.

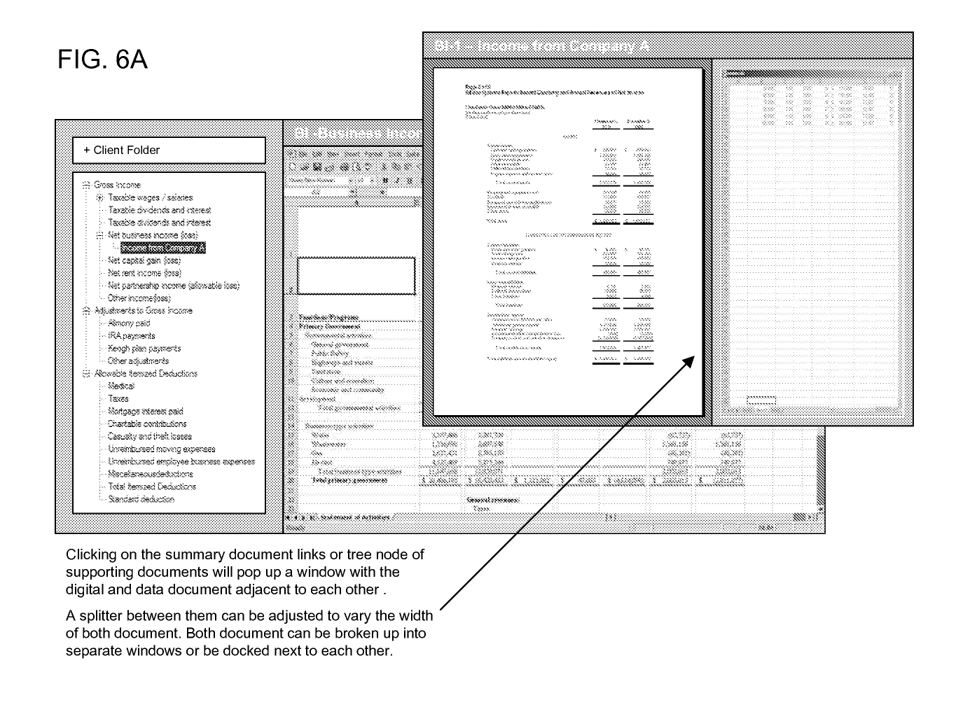

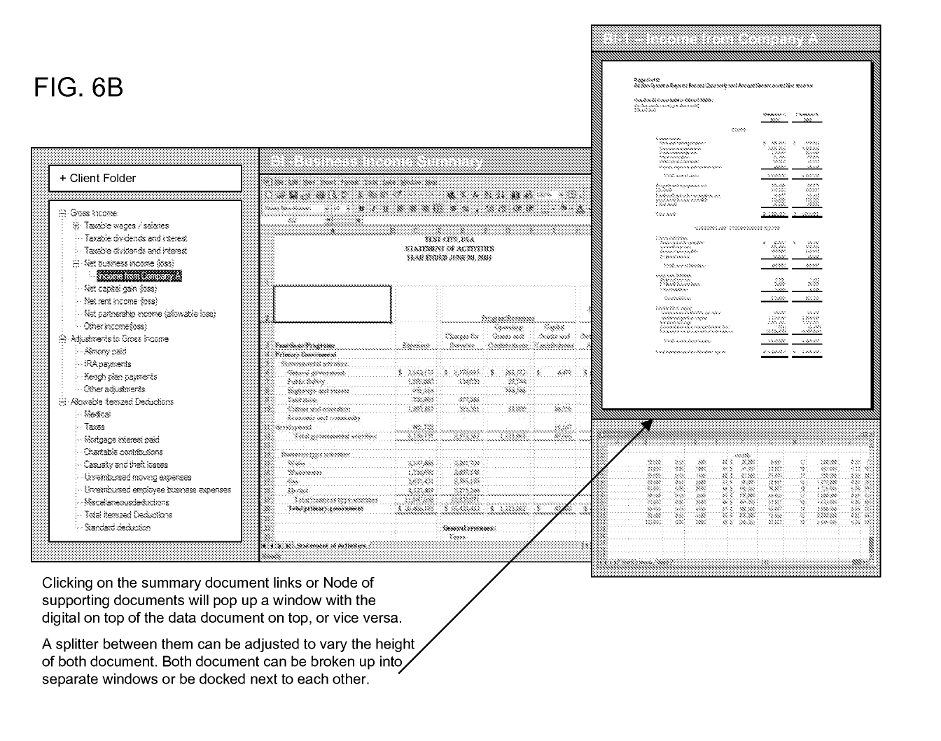

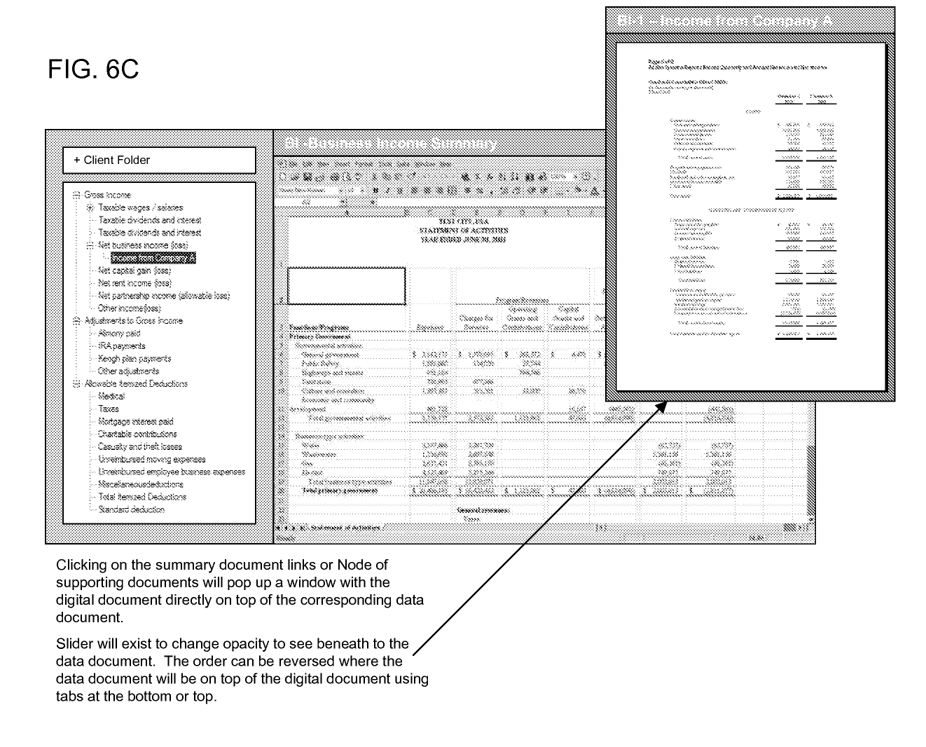

FIGS. 6A-6B exhibit three different ways to display the data document and the digital document when the hyperlinks on the summary documents are clicked on. FIG. 6A displays Audit Mode 1 where the data document 61A and the digital document 62A are adjacent to each other. FIG. 6B displays Audit Mode 2 where the data document 61B and the digital document 62B are stacked vertically. FIG. 6C displays Audit Mode 3 where digital document 61C overlaps the data document and vice versa.

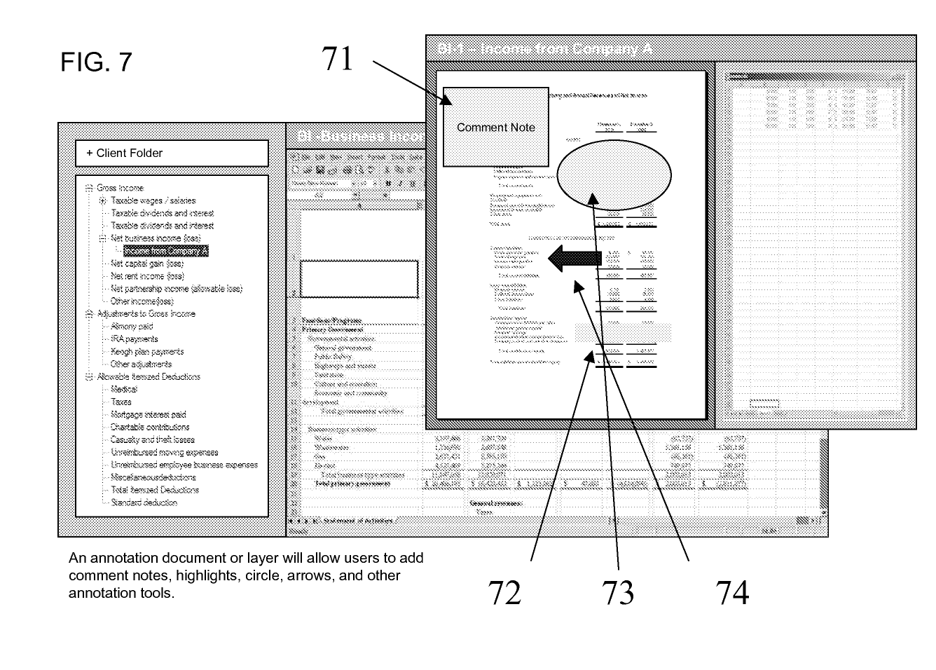

FIG. 7 displays the Annotation Mode where a transparent annotation document overlays a supporting document and allows user to add comment notes 71, highlights 72, circles 73, arrows 74, and other annotation tools.

What is claimed:

1. A method of creating hyperlinks between and among summary documents and supporting documents comprising:
creating a raw scan of a data from an original document;
converting the raw scan into a supporting document;
transferring the data from the supporting document to the summary document;
creating a hyperlink on the summary document to the supporting document;
and automatically renaming a filename of the supporting document when a user drags and drops the support document into an organizer.

2. A system of creating hyperlinks between and among summary documents and supporting documents comprising:
an original document;
a digital document;
a data document;
a note document;
a summary document;
and a document organizer.
